(19) United States
(12) Patent Application Publication
(10) Pub. No.: US 2009/0260947 A1
(43) Pub. Date: Oct. 22, 2009

(54) METHOD FOR PERFORMING CURRENCY VALUE ANALYSIS OPERATION

(76) Inventors: Xu-Hua Liu, Beijing (CN); Chung-Chieh Kuo, Taipei City (TW); Young-Min Kwak, Gardena, CA (US); Ying-Jieh Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/105,285

(22) Filed: Apr. 18, 2008

(51) Int. Cl. G07F 7/04

(52) U.S. Cl. 194/207

(57) ABSTRACT

A method for performing a currency value analysis operation on an image corresponding to at least a monetary banknote includes respectively assigning a plurality of bit values to a plurality of currency types and a plurality of currency values to create a currency type and value definition table; performing a color analysis operation on the image to generate a color analysis operation result; and determining a currency value of the monetary banknote according to at least the color analysis operation result and the currency type and value definition table.

### BACKGROUND OF THE INVENTION

1. Field of the Invention

The present invention relates to an image processing method, and more particularly, to a method for performing a currency value analysis operation.

2. Description of the Prior Art

Automated identification and verification of known currency bills is a practical application when applied to retail and business environments. Electronic verification of known bill types helps to increase security in monetary transactions, and also prevents vendors from receiving counterfeit currencies. Currency detectors available today typically scan an image of a sample currency, from which a series of tests is performed in order to determine the validity of the sample. The tests used can include the identification of known currency sections or landmarks, holograms, reflective areas, printing patterns, and texture patterns.

However, with advancements and availability of printing technologies, the occurrence of counterfeit currency or illegally copied currency has increased. Counterfeiters nowadays have access to sophisticated equipment and methods to duplicate known currencies that are virtually indistinguishable to the human eye and to the touch.

Improvements in graphics and image duplication systems, which can include scanners, digital color copiers, and printing machinery and apparatuses, have also contributed to the increase in illegal counterfeit reproduction of various items. Counterfeiters nowadays commonly attempt to reproduce monetary banknotes such as currencies, stocks, bonds, and other valuable items for personal gain and profit. The task of distinguishing and discerning between legitimate items and copied fakes is becoming increasingly difficult as printing and reproduction improvements allow copiers to reproduce banknotes that are virtually identical to legitimate ones. Therefore, there is a need to be able to effectively and precisely discern and distinguish counterfeit monetary banknotes from authentic ones.

The conventional process to detect numbers (e.g., OCR techniques) is as follows: (1) binarization, (2) open and close operations to improve the image, (3) number extraction from the background, usually by flood-fill operation, (4) skeleton extraction and then (5) content analysis which includes (a) rule based, (b) statistics based, (c) BP network based, etc. analyses.

According to the test, the conventional process is not suitable for some bills (such as USD bills and JPY bills) because the background around the numbers is complex and the number is different from an ordinary number. Usually, if the number can be easily extracted from a white background or from simple background with little noise, then the number can be recognized using OCR techniques. But for bills, there are some difficulties including when the number is connected with the background and can't be extracted simply, and when some numbers representing the bill value are not complete or clean after binarization.

### SUMMARY OF THE INVENTION

One objective of the claimed invention is therefore to provide a method for performing a currency value analysis operation.

In accordance with an exemplary embodiment of the claimed invention, a method for performing a currency value analysis operation on an image corresponding to at least a monetary banknote is disclosed. The method comprises: respectively assigning a plurality of bit values to a plurality of currency types and a plurality of currency values to create a currency type and value definition table; performing a color analysis operation on the image to generate a color analysis operation result; and determining a currency value of the monetary banknote according to at least the color analysis operation result and the currency type and value definition table.

In accordance with an exemplary embodiment of the claimed invention, a method for performing a currency value analysis operation on an image corresponding to at least a monetary banknote is disclosed. The method comprises: respectively assigning a plurality of bit values to a plurality of currency types and a plurality of currency values to create a currency type and value definition table; performing a color analysis operation on the image to generate a color analysis operation result; extracting color information from at least a specific local area of the image; and determining the currency value of the monetary banknote according to the color information, the color analysis operation result, and the currency type and value definition table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for performing the currency value analysis operation on the image corresponding to the monetary banknote in accordance with an embodiment of the present invention.

FIG. 2 shows an illustration of a bit-wise currency type and currency value definition table.

FIG. 3 is a flowchart of a method for performing the currency value analysis operation on the image corresponding to the monetary banknote in accordance with a second embodiment of the present invention.

FIG. 4 shows an illustration for extracting color information from the four corners of the image.

### DETAILED DESCRIPTION

The present invention relates to a method for performing a currency value analysis operation, and this document will describe several exemplary embodiments that apply the method of the present invention. However, a person of average skill in the pertinent art should understand that the present invention can be applied to various types of monetary banknotes and is not limited to the particular embodiments described in the following paragraphs or to the particular manner in which any features of such embodiments are implemented.

In general, the method of the present invention can be applied to all kinds of monetary banknotes. For example, the method of the present invention can be applied to European currency, Chinese currency, Taiwanese currency, American currency, and Japanese currency. However, this is only for illustrative purposes and is not meant to be a limitation of the present invention. In addition, under conditions not affecting the technical disclosure of the present invention, European currency, Chinese currency, Taiwanese currency, American currency, and Japanese currency will be used in this document as examples to illustrate the operation principles of the method according to the present invention.

The present invention contained herein provides a method for performing a currency value analysis operation on an image corresponding to the monetary banknote. The image can be provided from a hardware scanner or a similar device, where the image can contain sample monetary banknotes of a predetermined currency type. The types of currencies can include European, Chinese, Taiwanese, American, and Japanese currencies, but additional embodiments can also include currencies of other nationalities.

The described method can be applied for preventing the counterfeiting of currency. The scanned image can provide the sample monetary banknotes with an arbitrary rotational shift alignment within the image. This allows a common scanner to be used, instead of a simple banknote reader with fixed input dimensions. Additionally, the scanned image can contain the sample monetary banknotes while superimposed onto an arbitrary background, can contain multiple isolated or independent banknotes, or have overlapping banknotes. The method can be used in conjunction with basic stand-alone scanners, copiers, stand-alone printers, and other related detection and scanning hardware.

The method described in this present invention makes use of new innovations not introduced by the prior art. This not only provides an increased means of security measures when used for anti-counterfeit banknote, it also provides ease of integration with common hardware devices and a viable low-cost approach. It is also robust and flexible enough to be applied to a wide variety of image types and conditions.

Prior to a concise description of the present invention verification method, it is important to understand that certain terms used throughout the following description and claims will refer to particular processes or steps. As one skilled in the art will appreciate, designers may refer to such processes by different names. This document does not intend to distinguish between items that differ in name but function. In the following discussion and in the claims, the terms “including” and “comprising” are used in an open-ended fashion, and thus should be interpreted to mean “including, but not limited to . . . ”. Other examples are equally applicable, and should be understood to those familiar with the proper terminology of the related art.

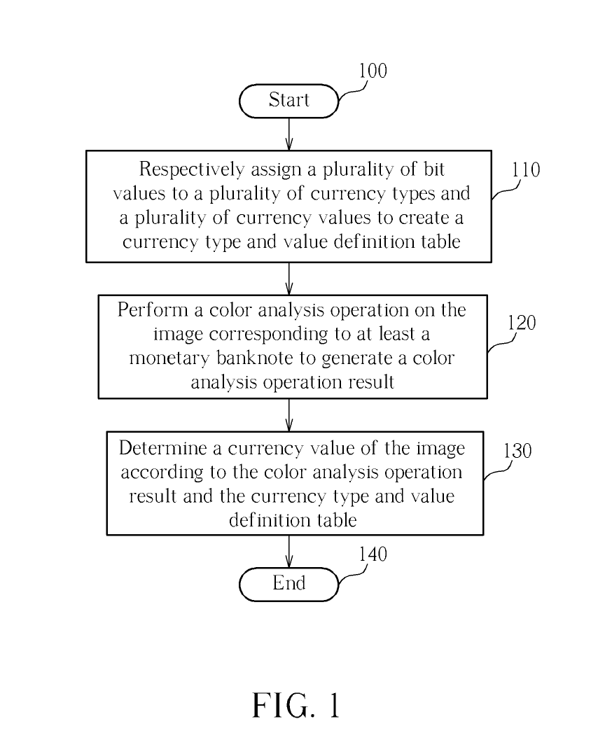

Please refer to FIG. 1. FIG. 1 is a flowchart of a method for performing the currency value analysis operation on the image corresponding to the monetary banknote in accordance with a first embodiment of the present invention. Provided that substantially the same result is achieved, the steps of process need not be in the exact order shown and need not be contiguous: other steps can be intermediate. The present invention method comprises:

Step 100: Start.

Step 110: Respectively assign a plurality of bit values to a plurality of currency types and a plurality of currency values to create a currency type and value definition table.

Step 120: Perform a color analysis operation on the image corresponding to at least a monetary banknote to generate a color analysis operation result.

Step 130: Determine a currency value of the image according to the color analysis operation result and the currency type and value definition table.

Step 140: End.

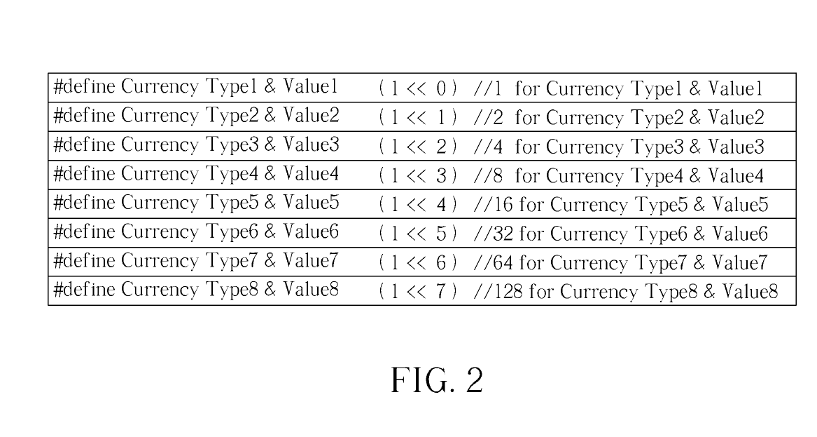

The first embodiment method of the present invention can be applied to all kinds of the bills (such as EUR bills, RMB bills, NTD bills, USD bills, and JPY bills). Please refer to FIG. 2. FIG. 2 shows an illustration of a bit-wise currency type and currency value definition table. When the bit-wise currency type and currency value definition table is utilized, different currency types and currency values can be recognized according to the different bit values.

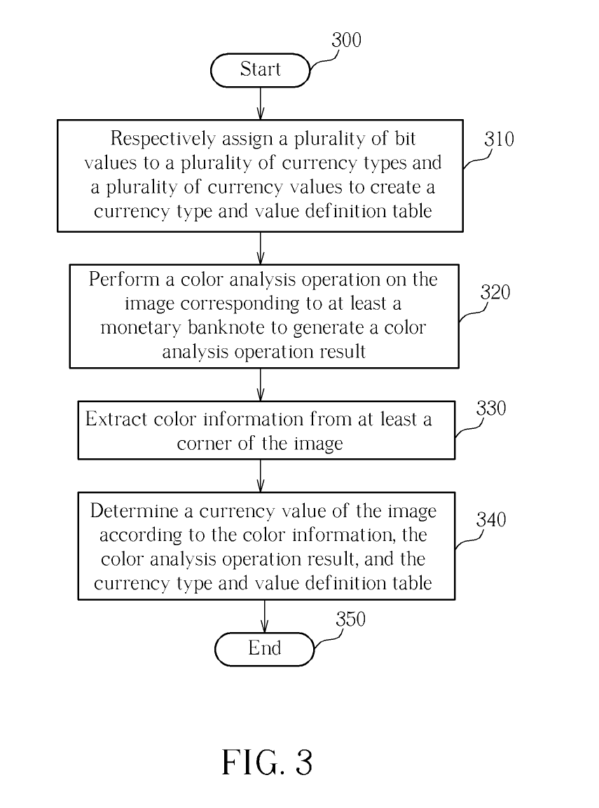

Please refer to FIG. 3. FIG. 3 is a flowchart of a method for performing the currency value analysis operation on the image corresponding to the monetary banknote in accordance with a second embodiment of the present invention. Provided that substantially the same result is achieved, the steps of process need not be in the exact order shown and need not be contiguous: other steps can be intermediate. The present invention method comprises:

Step 300: Start.

Step 310: Respectively assign a plurality of bit values to a plurality of currency types and a plurality of currency values to create a currency type and value definition table.

Step 320: Perform a color analysis operation on the image corresponding to at least a monetary banknote to generate a color analysis operation result.

Step 330: Extract color information from at least a corner of the image.

Step 340: Determine a currency value of the image according to the color information, the color analysis operation result, and the currency type and value definition table.

Step 350: End.

The second embodiment method of the present invention can be applied to the bills having a boundary (such as USD and JPY bills). As the location and rotation of the bills have been determined after the regional verification and the results are accurate since the boundary is used to remove the background noise, the bill location and rotation information can be used to detect values of USD and JPY bills. The present invention can extract color information from at least a specific local area of the image to distinguish the bill value for USD and JPY bills. For example, there are two steps to detect values of USD and JPY bills: (1) extracting color information from the four corners of the image, and (2) recognizing the numbers according to the color information.

(1) Extracting Color Information from the Four Corners of the Image

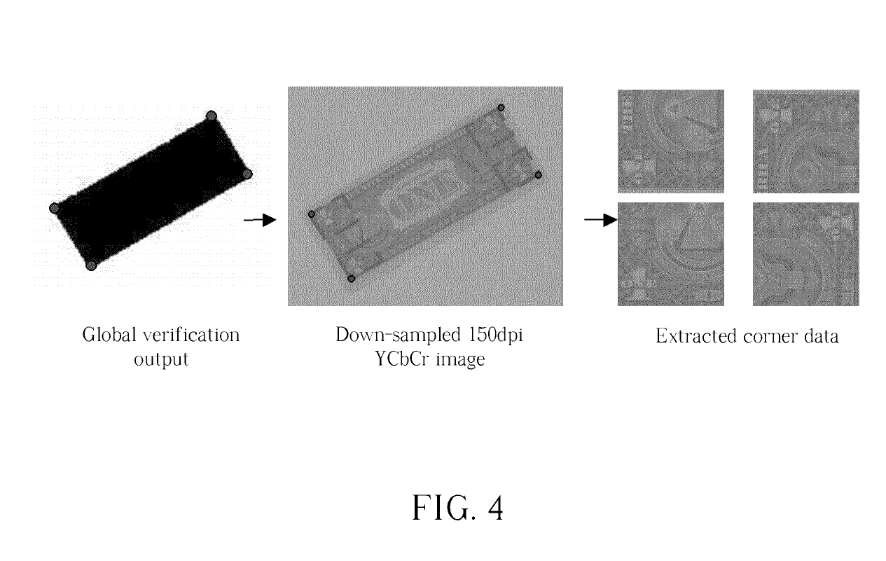

Please refer to FIG. 4. FIG. 4 shows an illustration of extracting color information from the four corners of the image. In order to extract the four corners from the original image (such as a down-sampled 150 dpi image), at first the four corner points in the blocked image should be determined. In a shape function, there are two scanning approaches: one is horizontal scanning and the other is zig-zag scanning. We use several shape criteria except a W/H ratio to choose the correct scanning order and then to obtain the correct coordination of the four corner points. A group of rotation formulas are used to get each corner matrix from the original YCbCr image according to the four corner points. For the convenience to view the result, the YCbCr image is displayed by RGB format. However, please note that the above embodiments are only for illustrative purposes and are not meant to be limitations of the present invention, i.e., the present invention is not limited to YCbCr color space for the original image.

(2) Recognizing the Numbers According to the Color Information

When carefully observing each number on the two sides (head and tail) of all of the USD bills, it is obvious that each side has a different corner color set at the four corners. For example, supposing the bill corner colors may include A, B, C, and D, then the USD1 bill may use four As, USD5 may use four Bs, and US10 may use three As and a C, and so on. Thus, the corner colors can be used to differentiate the bill value. In addition, since the USD100 needs a large corner matrix that can include the complete number 100 while its rotation is unknown, a large corner matrix has to be extracted to analyze the colors, and the background colors also have to be considered. Thus, the corner color selection should be strict under this condition.

For example, the USD20 and USD50 have obvious different corner colors from other bills. The head sides of USD1, USD5, USD10 and USD100 have similar corner colors, whereas the tail sides of USD1, USD5, USD10 and USD100 have similar corner colors. Thus, different color sets can be selected for every set of USD bills. For bills having similar colors, the same color may have different color counts, which can then be used to differentiate the similar bills, while JPY bill has different colors, so that it is easier to recognize the JPY bill values than to recognize the USD bill values. Please note that the above embodiments are only for illustrative purposes and are not meant to be limitations of the present invention.

Briefly summarized, use of the present invention method not only provides an increased means of security measures when used for counterfeit banknote detection, it also provides ease of integration with common hardware devices and a viable low cost approach. Accurate detection rates with low false detection frequencies can therefore be attained. The method is also robust and flexible enough to be applied to different image types and conditions.

Those skilled in the art will readily observe that numerous modifications and alterations of the device and method may be made while retaining the teachings of the invention.

What is claimed is:

1. A method for performing a currency value analysis operation on an image corresponding to at least a monetary banknote, the method comprising:
respectively assigning a plurality of bit values to a plurality of currency types and a plurality of currency values to create a currency type and value definition table;
performing a color analysis operation on the image to generate a color analysis operation result; and
determining a currency value of the monetary banknote according to at least the color analysis operation result and the currency type and value definition table.

2. The method of claim 1, wherein the monetary banknote has a boundary.

3. The method of claim 2, wherein the monetary banknote comprises United States of America currency or Japanese currency.

4. The method of claim 1, wherein the monetary banknote has no boundary.

5. The method of claim 4, wherein the monetary banknote comprises European currency, Chinese currency, or Taiwanese currency.

6. A method for performing a currency value analysis operation on an image corresponding to at least a monetary banknote, the method comprising:
respectively assigning a plurality of bit values to a plurality of currency types and a plurality of currency values to create a currency type and value definition table;
performing a color analysis operation on the image to generate a color analysis operation result;
extracting color information from at least a specific local area of the image; and
determining the currency value of the monetary banknote according to the color information, the color analysis operation result, and the currency type and value definition table.

7. The method of claim 6, wherein the monetary banknote has a boundary.

8. The method of claim 7, wherein the monetary banknote comprises American currency or Japanese currency.

9. The method of claim 6, wherein the specific local area of the image comprises a corner of the image or other landmarks of the image.

10. The method of claim 6, wherein the specific local area of the image comprises a corner of the image and other landmarks of the image.
